(19) United States
(12) Patent Application Publication
(10) Pub. No.: US 2010/0184879 A1
(43) Pub. Date: Jul. 22, 2010

(54) FOAMED ISOCYANATE-BASED POLYMER

(76) Inventors: Romeo Stanciu, Toronto (CA); Paul V. Farkas, Willowdale (CA); Hamdy Khalil, Willowdale (CA); Askar Karami, Etobicoke (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/529,273

(22) PCT Filed: Mar. 3, 2008
(86) PCT No.: PCT/CA08/00394

§ 371 Date: Apr. 1, 2010

Related U.S. Application Data
(60) Provisional application No. 60/904,359, filed on Mar. 2, 2007.

(51) Int. Cl. C08J 9/00; C09K 3/00

(52) U.S. Cl. 521/170; 252/182.24

(57) ABSTRACT

There is described a novoel isocyanate-based polymer foam. The isocyanate-based polymer foam is derived from a reaction mixture comprising: (a) an isocyanate; (b) a mixture of active hydrogen-containing compounds; and (c) a blowing agent. The mixture of active hydrogen-containing compounds comprises: (i) a bio-based polyol having an OH functionality of greater than about 2.0, an OH number in the range of from about 90 to about 200 and a molecular weight (Mn) of at least about 1100, and (ii) a petroleum-based active hydrogen-containing compound. It has been surprisingly and unexpectedly discovered that relatively high amounts (compared to the prior art) of such a bio-based polyol may be incorporated into an isocyanate-based polymer foam while maintaining a desirable balance of properties in the foam. Use of such a bio-based polyol (as a single bio-based polyol or a mixture of bio-based polyols) allows for displacement of at least a portion of petroleum-based polyols conventionally used in the production of isocyanate-based polymer foam while maintaining a desirable balance of properties in the foam, particularly molded foam. The addition benefit is that such displacement is of a component that this non-renewable and relatively more expensive than bio-based polyols.

### FIELD OF THE INVENTION

In one of its aspects, the present invention relates to a novel foamed isocyanate-based polymer. In another of its aspects, the present invention relates to a process for the production of such a foamed isocyanate-based polymer. In yet another of its aspects, the present invention relates to the discovery that relatively high amounts (compared to the prior art) of a bio-based polyol may be incorporated into an isocyanate-based polymer foam while maintaining a desirable balance of properties in the foam. Use of such a bio-based polyol (as a single bio-based polyol or a mixture of bio-based polyols) allows for displacement of at least a portion of petroleum-based polyols conventionally used in the production of isocyanate-based polymer foam while maintaining a desirable balance of properties in the foam, particularly molded foam.

### DESCRIPTION OF THE PRIOR ART

Isocyanate-based polymers are known in the art. Generally, those of skill in the art understand isocyanate-based polymers to be polyurethanes, polyureas, polyisocyanurates and mixtures thereof.

It is also known in the art to produce foamed isocyanate-based polymers. Indeed, one of the advantages of isocyanate-based polymers compared to other polymer systems is that polymerization and foaming can occur in situ. This results in the ability to mold the polymer while it is forming and expanding.

One of the conventional ways to produce a polyurethane foam is known as the “one-shot” technique. In this technique, the isocyanate, a suitable polyol, a catalyst, water (which acts as a reactive “blowing” agent and can optionally be supplemented with one or more physical blowing agents) and other additives are mixed together at once using, for example, impingement mixing (e.g., high pressure). Generally, if one were to produce a polyurea, the polyol would be replaced with a suitable polyamine. A polyisocyanurate may result from cyclotrimerization of the isocyanate component. Urethane modified polyureas or polyisocyanurates are known in the art. In either scenario, the reactants would be intimately mixed very quickly using a suitable mixing technique.

Another technique for producing foamed isocyanate-based polymers is known as the “prepolymer” technique. In this technique, a prepolymer is produced by reacting polyol and isocyanate (in the case of a polyurethane) in an inert atmosphere to form a liquid polymer terminated with reactive groups (e.g., isocyanate moieties and active hydrogen moieties). To produce the foamed polymer, the prepolymer is thoroughly mixed with a lower molecular weight polyol (in the case of producing a polyurethane) or a polyamine (in the case of producing a modified polyurea) in the presence of a curing agent and other additives, as needed.

Regardless of the technique used, it is known in the art to include a filler material in the reaction mixture. Conventionally, filler materials have been introduced into foamed polymers by loading the filler material into one or both of the liquid isocyanate and the liquid active hydrogen-containing compound (i.e., the polyol in the case of polyurethane, the polyamine in the case of polyurea, etc.). Generally, incorporation of the filler material serves the purpose of conferring so-called loaded building properties to the resulting foam product.

The nature and relative amounts of filler materials used in the reaction mixture can vary, to a certain extent, depending on the desired physical properties of the foamed polymer product, and limitations imposed by mixing techniques, the stability of the system and equipment imposed limitations (e.g., due to the particle size of the filler material being incompatible with narrow passages, orifices and the like of the equipment).

More recently, there has been an effort to produce isocyanate-based polymer foams using so called bio-based polyols. See, for example, one or more of the following documents:

United States patent application publication S.N. 2005/0070620 [Herrington et al.];

United States patent application publication S.N. 2005/0239915 [Provan];

United States patent application publication S.N. 2005/0282921 [Flanigan et al.];

United States patent application publication S.N. 2006/0223723 [Provan];

United States patent application publication S.N. 2006/0229375 [Hsiao et al.];

United States patent application publication S.N. 2006/0264524 [Abraham et al.]; and

United States patent application publication S.N. 2006/0270747 [Griggs].

Bio-based polyols are polyols which are produced using a naturally occurring material such as vegetable oil. Examples of vegetable oils that have been used to produce bio-based polyols include soy oil, castor oil, safflower oil, sesame oil, peanut oil, cottonseed oil, olive oil, linseed oil, palm oil, canola oil and blends thereof.

Much of this effort has been founded on the need in the art for isocyanate-based polymer foams made with environmentally-friendly, renewable components. Despite these efforts, it has not been possible to produce such isocyanate-based polymer foams having the requisite properties, particularly molded isocyanate-based polymer foams having a desirable balance of physical properties.

Specifically, using the known approaches of incorporating bio-based polyols into a molded foam, one or more of the following properties has been compromised:
energy dissipation;
hardness;
compression set;
flame retardency;
tensile strength;
compression set (dry and wet);
tensile strength;
tear strength;
elongation;
resiliency;
hysteresis;
friendly touch;
low fogging; and
non-staining.

Thus, it would be desirable to have an isocyanate-based polymer foam having a desirable balance of these properties. It would be further desirable to have a technique using a bio-based polyol to displace at least a portion of the amount of petroleum-based polyols in current use. It would be further desirable if such a technique: was relatively cost stable and/or resulted in improved other properties of the polyurethane foam and/or could be incorporated into an existing production scheme without great difficulty.

### SUMMARY OF THE INVENTION

It is an object of the present invention to obviate or mitigate at least one of the above-mentioned disadvantages of the prior art.

It is another object of the present invention to provide a novel isocyanate-based foam which obviates or mitigates at least one of the above-mentioned disadvantages of the prior art.

It is another object of the present invention to provide a novel process for producing an isocyanate-based polymer foam.

Accordingly, in one of its aspects, the present invention provides an isocyanate-based polymer foam derived from a reaction mixture comprising:

(a) an isocyanate;

(b) a mixture of active hydrogen-containing compounds; and

(c) a blowing agent;

wherein the mixture of active hydrogen-containing compounds comprises: (i) a bio-based polyol having an OH functionality of greater than about 2.0, an OH number in the range of from about 90 to about 200 and a molecular weight (Mn) of at least about 1100, and (ii) a petroleum-based active hydrogen-containing compound.

In another of its aspects, the present invention provides a process for producing an isocyanate-based polymer comprising the steps of:

(i) forming a reaction mixture comprising (a) an isocyanate; (b) a mixture of active hydrogen-containing compounds; and (c) a blowing agent; wherein the mixture of active hydrogen-containing compounds comprises: (i) a bio-based polyol having an OH functionality of greater than about 2.0, an OH number in the range of from about 90 to about 200 and a molecular weight (Mn) of at least about 1100, and (ii) a petroleum-based active hydrogen-containing compound; and

(ii) expanding the reaction mixture to produce the isocyanate-based polymer foam.

In yet another of its aspects, the present invention provides a polyol composition comprising: (i) a first modified vegetable oil-based polyol having an OH functionality greater than about 2, an OH number greater than about 100 and a molecular weiht (Mn) of less than about 1500; and (ii) a second modified vegetable oil-based polyol different than the first modified vegetable oil-based polyol, the second modified vegetable oil-based polyol having an OH functionality less than about 2, an OH number less than about 100 and a molecular weight (Mn) of greater than about 1000.

Thus, the present inventors have surprisingly and unexpectedly discovered that relatively high amounts (compared to the above-mentioned prior art) of a bio-based polyol may be incorporated into an isocyanate-based polymer foam while maintaining a desirable balance of properties in the foam. This can be accomplished by careful selection of the bio-based polyol. Specifically, the bio-based polyol should have the following combination of properties: (i) an OH functionality of greater than about 2.0, (ii) an OH number in the range of from about 90 to about 200 and (ii) a molecular weight (Mn) of at least about 1100. Use of a bio-based polyol (as a single bio-based polyol or a mixture of bio-based polyols) having this combination of properties allows for displacement of at least a portion of petroleum-based polyols conventionally used in the production of isocyanate-based polymer foam while maintaining a desirable balance of properties in the foam, particularly molded foam. The addition benefit is that such displacement is of a component that this non-renewable and relatively more expensive than bio-based polyols.

### DETAILED DESCRIPTION OF THE PREFERRED EMBODIMENTS

In one of its aspects, the present invention relates to a foamed isocyanate-based polymer. Preferably, the isocyanate-based polymer is selected from the group comprising polyurethane, polyurea, polyisocyanurate, urea-modified polyurethane, urethane-modified polyurea, urethane-modified polyisocyanurate and urea-modified polyisocyanurate. As is known in the art, the term “modified”, when used in conjunction with a polyurethane, polyurea or polyisocyanurate means that up to 50% of the polymer backbone forming linkages have been substituted.

Typically, the foamed isocyanate-based polymer is produced from a reaction mixture which comprises an isocyanate, a petroleum-based active hydrogen-containing compound and a vegetable oil-based polyol.

The isocyanate suitable for use in the reaction mixture is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g., an alkylene or arylene group). Moreover, Q may be represented by the general formula:

Q¹-Z-Q¹

wherein Q¹ is an alkylene or arylene group and Z is chosen from the group comprising —O—, —O-Q¹-, —CO—, —S—, —S-Q¹-S— and —SO₂—. Examples of isocyanate compounds which fall within the scope of this definition include hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4′-diisocyanate, naphthalene-1,5-diisocyanate, triphenylmethane-4,4′,4″-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as defined hereinabove) with a petroleum based active hydrogen-containing compound (as defined hereinafter), preferably the polyhydroxyl-containing materials or polyols described below, or a vegetable oil-based polyol. In this embodiment, the polyisocyanate may be, for example, used in proportions of from about 30 percent to about 200 percent stoichiometric excess with respect to the proportion of hydroxyl in the polyol. Since the process of the present invention may relate to the production of polyurea foams, it will be appreciated that in this embodiment, the prepolymer could be used to prepare a polyurethane modified polyurea.

In another embodiment, the isocyanate compound suitable for use in the process of the present invention may be selected from dimers and trimers of isocyanates and diisocyanates, and from polymeric diisocyanates having the general formula:

Q′[(NCO)ᵢ]ⱼ

wherein both i and j are integers having a value of 2 or more, and Q′ is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also for example, British patent number 1,453,258, for a discussion of suitable isocyanates.

Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof.

A more preferred isocyanate is selected from the group comprising 2,4-toluene diisocyanate, 2,6-toluene diisocyanate and mixtures thereof, for example, a mixture comprising from about 75 to about 85 percent by weight 2,4-toluene diisocyanate and from about 15 to about 25 percent by weight 2,6-toluene diisocyanate. Another more preferred isocyanate is selected from the group comprising 2,4′-diphenylmethane diisocyanate, 4,4′-diphenylmethane diisocyanate and mixtures thereof.

The most preferred isocyanate is a mixture of diphenylmethane diisocyanate (as discussed above) and toluene diisocyanate (as discussed above) in various ratios.

If the process is utilized to produce a polyurethane foam, the petroleum-based active hydrogen-containing compound is typically a polyol. The choice of polyol is not particularly restricted and is within the purview of a person skilled in the art. For example, the polyol may be a hydroxyl-terminated backbone of a member selected from the group comprising polyether, polyester, polycarbonate, polydiene and polycaprolactone. Preferably, the polyol is selected from the group comprising hydroxyl-terminated polyhydrocarbons, hydroxyl-terminated polyformals, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyols are selected from the group comprising adipic acid-ethylene glycol polyester, poly(butylene glycol), poly(propylene glycol) and hydroxyl-terminated polybutadiene—see, for example, British patent number 1,482,213, for a discussion of suitable polyols. Preferably, such a polyether polyol has a molecular weight in the range of from about 100 to about 10,000, more preferably from about 100 to about 4,000, most preferably from about 100 to about 3,500.

If the present isocyanate-based polymer foam is a polyurea foam, the petroleum-based active hydrogen-containing compound comprises compounds wherein hydrogen is bonded to nitrogen. Preferably such compounds are selected from the group comprising polyamines, polyamides, polyimines and polyolamines, more preferably polyamines. Non-limiting examples of such compounds include primary and secondary amine terminated polyethers. Preferably such polyethers have a molecular weight of greater than about 100 and a functionality of from 1 to 25. Such amine terminated polyethers are typically made from an appropriate initiator to which a lower alkylene oxide is added with the resulting hydroxyl terminated polyol being subsequently aminated. If two or more alkylene oxides are used, they may be present either as random mixtures or as blocks of one or the other polyether. For ease of amination, it is especially preferred that the hydroxyl groups of the polyol be essentially all secondary hydroxyl groups. Typically, the amination step replaces the majority but not all of the hydroxyl groups of the polyol.

Further, if the petroleum-based active hydrogen-containing compound is a polyol, the polyol may be in the form of a polymer polyol as described above. As is known in the art, such polyols are generally polyether polyol dispersions which are filled with other organic polymers. Such polymer polyols are useful in load building or improving the hardness of the foam when compared to using unmodified polyols. Non-limiting examples of useful polymer polyols include: chain-growth copolymer polyols (e.g., containing particulate poly(acrylonitrile), poly(styrene-acrylonitrile) and mixtures thereof), and/or step-growth copolymer polyols (e.g., PolyHarnstoff Dispersions (PHD), polyisocyanate polyaddition (PIPA) polyols, epoxy dispersion polyols and mixtures thereof). For further information on polymer polyols, see, for example, Chapter 3 (Raw Materials) of “Polyurtherane Handbook” edited by Günther Oertel (2^{nd} Edition (1994), Published by Hanser and the references cited therein. If a polymer polyol is used, it is preferred to admix the polymer polyol with a base polyol. Generally, mixtures may be used which contain polymer polyol in an amount in the range of from about 5 to about 50 percent by weight of unmodified polyol present in the mixture.

As used throughout this specification, the term “bio-based polyols” is a generic term intended to encompass polyols derived from renewable resources such as a vegetable oil or another bio-originated material.

The preferred bio-based polyol is a vegetable oil-based polyol. Non-limiting examples of suitable vegetable oils from which such a polyol may be derived include soybean oil, safflower oil, linseed oil, corn oil, sunflower oil, olive oil, canola oil, sesame oil, cottonseed oil, palm oil, rapeseed oil, tung oil, fish oil, peanut oil and combinations thereof. Also useful are partially hydrogenated vegetable oils and genetically modified vegetable oils, including high oleic safflower oil, high oleic soybean oil, high oleic peanut oil, high oleic sunflower oil and high erucic rapeseed oil (crambe oil).

A suitable method to prepare the bio-based (e.g., vegetable oil-based) polyol involves reacting the vegetable oil (or mixture of vegetable oils) with a peroxyacid, providing an epoxidized vegetable oil. Essentially, some or all of the double bonds of the vegetable oil may be epoxidized. The epoxidized vegetable oil may be further reacted with an alcohol, a catalytic amount of fluoroboric acid and, optionally, water to form the polyol. Such polyols contain all secondary hydroxyl groups.

These bio-based polyols may be used directly in a reaction mixture to produce an isocyanate-based foam such as a polyurethane foam. Alternatively, the bio-based polyols may be reacted with the epoxidized vegetable oils described above in the presence of a fluoroboric acid catalyst and, optionally, water to form a bio-based polyol suitable for use in a reaction mixture to produce an isocyanate-based foam such as a polyurethane foam.

Examples of such preparations are described, for example, in one or more of

U.S. Pat. No. 6,686,435 [Petrovic et al.];

U.S. Pat. No. 6,107,433 [Petrovic et al.];

U.S. Pat. No. 6,573,354 [Petrovic et al.]; and

U.S. Pat. No. 6,433,121 [Petrovic et al.].

Alternatively, the epoxidation reaction may be conducted under conditions that result in a polyol having residual double bonds.

Also suitable are modified vegetable-oil based polyols prepared by a hydroformylation process. In this process, a vegetable oil is reacted with carbon monoxide and hydrogen in the presence of a Group VIII metal catalyst (e.g., a rhodium catalyst) to form a hydroformylated vegetable oil. The hydroformylated vegetable oil is then hydrogenated to form the modified vegetable oil-based polyol. This process produces polyols containing all primary hydroxyl groups. These polyols may be used directly in a reaction mixture to produce an isocyanate-based foam such as a polyurethane foam. Alternatively, they may be reacted with the epoxidized vegetable oils described above in the presence of a fluoroboric acid catalyst and, optionally, water to form a polyol suitable for use in a reaction mixture to produce an isocyanate-based foam such as a polyurethane foam.

As described above the present isocyanate-based polymer foam is derived from a reaction mixture that includes a bio-based polyol having an OH functionality of greater than about 2.0, an OH number in the range of from about 90 to about 200 and a molecular weight (Mn) of at least about 1100.

The bio-based polyol may be a single polyol or a mixture of polyols. In either case, it is preferred that the bio-based polyol is a vegetable oil-based polyol.

If the bio-based polyol is a single polyol, it is preferred that it has an OH functionality in the range of from about 2.5 to about 5.0, more preferably in the range of from about 2.5 to about 4.5, more preferably in the range of from about 2.5 to about 4.0, most preferably in the range of from about 2.8 to about 4.0. Further, it is preferred that the single polyol has an OH number in the range of from about 100 to about 200, more preferably in the range of from about 120 to about 180, more preferably in the range of from about 130 to about 170, most preferably in the range of from about 140 to about 160. Still further, it is preferred that the single polyol has a molecular weight (Mn) in the range of from about 1100 to about 1600, more preferably in the range of from about 1200 to about 1600, more preferably in the range of from about 1200 to about 1500, most preferably in the range of from about 1250 to about 1500.

Preferably, the bio-based polyol is a mixture of two or more bio-based polyols, more preferably two bio-based polyols.

When the bio-based polyol is a mixture of two or more bio-based polyols, it is preferably that the mixture comprise: (i) a first bio-based polyol having an OH functionality greater than about 2, an OH number greater than about 100 and a molecular weight (Mn) of less than about 1500; and (ii) a bio-based polyol different than the first bio-based polyol, the second bio-based polyol having an OH functionality less than about 2, an OH number less than about 100 and a molecular weight (Mn) of greater than about 1000.

Preferably, the first bio-based polyol has the following properties:
an OH functionality in the range of from about 2 to about 6, more preferably, in the range of from about 2.5 to about 5.5, more preferably in the range of from about 3.5 to about 5.5, most preferably in the range of from about 3.5 to about 4.5;
an OH number greater than about 125, more preferably in the range of from about 125 to about 300, more preferably in the range of from about 150 to about 275, more preferably in the range of from about 175 to about 275, most preferably in the range of from about 200 to about 250;
a molecular weight (Mn) in the range of from about about 500 to about 1500, more preferably in the range of from about about 800 to about 1200.

Preferably, the second bio-based polyol comprises epoxide moieties. In this respect, it is preferred to use a second bio-based polyol having the following properties:
an epoxy oxygen content (a method that may be used to determine the epoxy oxygen content is AOCS Cd9-57) of from about 0.1 to about 15 weight percent, more preferably from about 0.5 to about 10 weight percent, more preferably from about 1.0 to about 5.0 weight percent; and
an average epoxy functionality greater than about 0.5, more preferably greater than about 1.0, more preferably in the range of from about 2.0 to about 6.0, more preferably in the range of from about 3.0 to about 6.0, more preferably in the range of from about 3.0 to about 5.0, most preferably in the range of from about 3.5 to about 4.5.

Regardless of whether the second bio-based polyol comprises epoxide moieties, it is preferred to use a second bio-based polyol having the following properties:
OH functionality in the range of from about 0.5 to about 2.0, more preferably in the range of from about 0.8 to about 2.0, more preferably in the range of from about 1.0 to about 2.0, more preferably in the range of from about 1.3 to about 2.0, most preferably in the range of from about 1.5 to about 2.0;
an OH number in the range of from about 25 to about 100, more preferably in the range of from about 40 to about 80, most preferably in the range of from about 40 to about 60;
a molecular weight (Mn) of greater than about 1200, more preferably in the range of from about 1200 to about 2000, more preferably in the range of from about 1300 to about 2000, more preferably in the range of from about 1400 to about 2000, more preferably in the range of from about 1500 to about 2000, most preferably in the range of from about 1700 to about 1900.

The reaction mixture used to produce the foamed isocyanate-based polymer typically will further comprise a blowing agent. As is known in the art, water can be used as an indirect or reactive blowing agent in the production of foamed isocyanate-based polymers. Specifically, water reacts with the isocyanate forming carbon dioxide which acts as the effective blowing agent in the final foamed polymer product. Alternatively, the carbon dioxide may be produced by other means such as unstable compounds which yield carbon dioxide (e.g., carbamates and the like). Optionally, direct organic blowing agents may be used in conjunction with water although the use of such blowing agents is generally being curtailed for environmental considerations. The preferred blowing agent for use in the production of the present foamed isocyanate-based polymer comprises water.

It is known in the art that the amount of water used as an indirect blowing agent in the preparation of a foamed isocyanate-based polymer is conventionally in the range of from about 0.5 to as high as about 40 or more parts by weight, preferably from about 1.0 to about 10 parts by weight, based on 100 parts by weight of the total active hydrogen-containing compound content in the reaction mixture. As is known in the art, the amount of water used in the production of a foamed isocyanate-based polymer typically is limited by the fixed properties expected in the foamed polymer and by the tolerance of the expanding foam towards self structure formation.

To produce the foamed isocyanate-based polymer, a catalyst is usually incorporated in the reaction mixture. The catalyst used in the reaction mixture is a compound capable of catalyzing the polymerization reaction. Such catalysts are known, and the choice and concentration thereof in the reaction mixture is within the purview of a person skilled in the art. See, for example, U.S. Pat. Nos. 4,296,213 and 4,518,778 for a discussion of suitable catalyst compounds. Non-limiting examples of suitable catalysts include tertiary amines and/or organometallic compounds. Additionally, as is known in the art, when the objective is to produce an isocyanurate, a Lewis acid must be used as the catalyst, either alone or in conjunction with other catalysts. Of course it will be understood by those skilled in the art that a combination of two or more catalysts may be suitably used.

As will be clearly understood by those of skill in the art, it is contemplated that conventional additives in the polyurethane foam art can be used in the process used to produce the present foamed isocyanate-based polymer. Non-limiting examples of such additives include: filler materials, surfactants, cell openers (e.g., silicone oils), cross-linkers (e.g., low molecular weight reactive hydrogen-containing compositions), pigments/dyes, flame retardants (e.g., halogenated organo-phosphoric acid compounds), inhibitors (e.g., weak acids), nucleating agents (e.g., diazo compounds), anti-oxidants, UV stabilizers (e.g., hydroxybenzotriazoles, zinc dibutyl thiocarbamate, 2,6-ditertiary butylcatechol, hydroxybenzophenones, hindered amines and mixtures thereof), biocides, antistatic agents (e.g., ionizable metal salts, carboxylic acid salts, phosphate esters and mixtures thereof) and mixtures thereof. The amounts of these additives conventionally used is within the purview of a person skilled in the art—see, for example, Chapter 5 (Polyurethane Flexible Foams) of “Polyurtherane Handbook” edited by Günther Oertel (2^{nd} Edition (1994), Published by Hamer and the references cited therein.

The manner by which the isocyanate, the mixture of active hydrogen-containing compounds, blowing agent, catalyst and other additives (if present) are contacted in the present process is not particularly restricted. Thus, it is possible to preblend some of the components in a separate tank which is then connected to a suitable mixing device for mixing with the blowing agent and catalyst. Alternatively, it is possible to preblend the mixture of active hydrogen-containing compounds with the blowing agent, catalyst and other additives, if present, to form a resin. This resin preblend could then be fed to a suitable mixhead (high pressure or low pressure) which would also receive an independent stream of the isocyanate. Some components (e.g., a plasticizer) may be fed as a separate stream to the mixhead or into the resin stream via a suitable manifold or the like prior to the mixhead.

Once the mixture of active hydrogen-containing compounds, isocyanate, blowing agent, catalyst and other additives (if present) have been contacted and, ideally, mixed uniformly, a reaction mixture is formed. This reaction mixture is then expanded to produce the present foamed isocyanate-based polymer. As will be apparent to those of skill in the art, the process of the present invention is useful in the production of slabstock foam, molded articles and the like. The manner by which expansion of the reaction mixture is effected will be dictated by the type of foam being produced.

The present isocyanate-based polymer foam and process for production thereof are particularly well suited to molded foam, such as molded polyurethane foam. Such molded foams may be used in a number of applications, including automotive applications such as seat elements (e.g., seat bottom and/or seat back), headrests, bolsters, instrument panels, pillar covers, air bag door covers, other vehicular trim elements and the like.

An aspect of the present invention relates to a polyol composition comprising a first modified vegetable oil-based polyol (as defined above) and a second modified vegetable oil-based polyol (as defined above). The manner by which these two polyols are combined is not particularly restricted. For example, it is possible to combine the two polyols in a conventional blending station. It is also possible that the polyol composition contains one or more further ingredients used in the resin component to produce the isocyanate-based polymer foam—e.g., one or more of a petroleum-based polyol, catalyst, blowing agent, surfactant and the like discussed above.

Embodiments of the present invention will now be described with reference to the following Examples which should not be construed as limiting the scope of the invention. The term “pbw” used in the Examples refers to parts by weight. The molecular weight (Mn) of various components referred to in the Examples was determined using vapour pressure osmometry, and by gel permeation chromatography with petrochemical standards.

In the Examples, the following materials were used:

E-837, petroleum-based polyol, commercially available from Bayer;

V-4701, petroleum-based polyol, commercially available from Dow Chemicals;

E850, a 43% solids content petroleum-based copolymer (SAN) polyol, commercially available from Bayer;

SOBP #1, a soy oil-based polyol having an OH number of approx. 57-59, a molecular weight (Mn) of approx. 1700-1800 and an OH functionality of approx. 1.8;

SOBP #2, a soy oil-based polyol having an OH number of approx. 225-240, a molecular weight (Mn) of approx. 900-1200 and an OH functionality of approx. 3.9-4.4;

ISO #1, prepolymer of MDI and a flexible polyether triol (molecular weight=4000) and having an NCO content of 28% by weight;

ISO #2, 80/20 blend of MDI variant and TDI; the blend has an NCO content of 36% by weight;

PC77, a catalyst, commercially available from Air Products;

Water, an indirect blowing agent;

33LV, a gelation catalyst, commercially available from Air Products;

DEOA-LF, diethanolamine, a cross-linking agent commercially available from Air Products;

ZF-10, amine catalyst; commercially available from Huntsman Chemicals;

V-4053, cell opener; commercially available from Dow Chemicals;

Y-10858, surfactant; commercially available from G.E. Silicones;

B-4690, foam stabilizer; commercially available from Degussa;

B-4113, surfactant; commercially available from Degussa;

L-3165, surfactant; commercially available from G.E. Silicones;

Ultra-Fresh FP-1 (Biocide), anti-bacterial agent; commercially available from Thomson Research;

B-8240, surfactant; commercially available from Degussa; and

BL19, a blowing catalyst, commercially available from Air Products.

In the examples various foam samples were produced using the following general methodology.

A resin blend masterbatch was prepared by adding the stated amount of each component except the isocyanate to a 3 L plastic bucket. The resin blend masterbatch was mixed for 30 minutes using a high torque, laboratory mixer, at 1750 rpm and 23° C. The resin masterbatch and the isocyanate were conditioned at 25° C. for one hour, prior to be used for the preparation of the moulded foam samples.

The required amount of resin blend, measured in a 1.5 L paper (Dixie) cup, was pre-mixed at 1750 rpm for 30 seconds using a Delta Ø 2″ lab mixer. The required amount of isocyanate was added under continuous mixing and the timer was started. The resin blend/isocyanate combination was mixed for 10 seconds and then poured into an aluminum test mould, heated at 65° C.

The resulting foam was demoulded after 6 minutes, hand crushed, allowed to cool and kept for seven days at ˜23° C. and ˜50% relative humidity before testing for properties.

The foam samples were subjected to a variety of physical tests including:

| Physical Property | Test Method | Notes |
|---|---|---|
| Density | ASTM D3574 (A) | — |
| Resiliency | ASTM D3574 (H) | — |
| 50% Identation | ASTM D3574 (B1) | 203 mm diameter circular |
| Load Deflection | | indentor @ 50 (±5) mm/min. |
| 50% Compression | ASTM D3574 (D) | 22 hrs. @ 70° C. (±2° C.) |
| Set | | |
| 50% Humid Aged | ASTM D3574 (J1) | steam autoclave, 3 hrs. @ |
| Compression Set | | 105° C. (±3° C.) |
| (HACS) | | |
| Tear Strength | ASTM D3574 (F) | — |
| Tensile Strength | ASTM D3574 (E) | — |
| Elongation | ASTM D3574 (E) | — |
| (at break) | | |

### EXAMPLES 1-3

In these Examples, various foam samples were produced using the formulations set out in Table 1 and the general methodology described above.

As will be apparent, neither Example 1 nor Example 2 were based on a formulation containing a vegetable oil-based polyol having an OH functionality (overall) of greater than about 2.0, an OH number (overall) in the range of from about 90 to about 200 and a molecular weight (Mn) (overall) of at least about 1100. Accordingly, the foams produced in Examples 1 and 2 are provided for comparative purposes only and are outside the scope of the invention.

As will be further apparent, Example 3 was based on a formulation containing a mixture of vegetable oil-based polyols which, as a mixture, had an OH functionality of 3.4, an OH number of 145.5 and a molecular weight (Mn) of 1310. Accordingly, the foam produced in Example 3 is within the scope of the present invention.

The results of physical testing of the foams produced in Examples 1-3 are set out in Table 2.

With reference to Table 2, it can be seen that the foam produced in Example 1 had good tear strength and tensile strength; however, the 50% compression set and 50% humid aged compression set of the foam were significantly compromised. Conversely, the foam produced in Example 2 had good 50% compression set and 50% humid aged compression set; however, the tear strength and tensile strength of the foam were significantly compromised. The degradation of properties in the foams produced in Examples 1 and 2 was such that these foams would not be useful in most applications for molded foams—e.g., vehicular applications.

With further reference to Table 2, surprisingly and unexpectedly, it can be seen that the foam produced in Example 3 had a very desirable combination of tear strength, tensile strength, compression set and humid aged compression set. The foam produced in Example 3 has a combination of properties that is clearly superior to that of the foams produced in Examples 1 and 2.

### EXAMPLES 4-7

In these Examples, various foam samples were produced using the formulations set out in Table 3 and the general methodology described above.

As will be apparent, none of Examples 4-6 were based on a formulation containing a vegetable oil-based polyol having an OH functionality (overall) of greater than about 2.0, an OH number (overall) in the range of from about 90 to about 200 and a molecular weight (Mn) (overall) of at least about 1100. Accordingly, the foams produced in Examples 4-6 are provided for comparative purposes only and are outside the scope of the invention.

As will be further apparent, Example 7 was based on a formulation containing a mixture of vegetable oil-based polyols which, as a mixture, had an OH functionality of 2.95, an OH number of 117 and a molecular weight (Mn) of 1420. Accordingly, the foam produced in Example 7 is within the scope of the present invention.

The results of physical testing of the foams produced in Examples 4-7 are set out in Table 4.

With reference to Table 4, it can be seen that the foam produced in Example 5 had relatively good tensile properties; however, the 50% compression set and 50% humid aged compression set of the foam were significantly compromised and the foam is very hard (re. ILD=729 N). The foam produced in Example 6 had diminished tensile properties and the 50% compression set and 50% humid aged compression set deteriorated even further (i.e., compared to the foam produced in Example 5). The degradation of properties in the foams produced in Examples 5 and 6 was such that these foams would not be useful in most applications for molded foams—e.g., vehicular applications.

With further reference to Table 4, surprisingly and unexpectedly, it can be seen that the foam produced in Example 7 had a very desirable combination of tear strength, tensile strength, 50% compression set and 50% humid aged compression set. The foam produced in Example 7 has a combination of properties that is clearly superior to that of the foams produced in Examples 5 and 6. Further, the foam produced in Example 7 has a combination of properties that, on balance, is quite desirable when compared with a conventional foam made using a polymer polyol as a load building component (Example 4).

### EXAMPLES 8-11

In these Examples, various foam samples were produced using the formulations set out in Table 5 and the general methodology described above.

As will be apparent, none of Examples 8-10 were based on a formulation containing a vegetable oil-based polyol having an OH functionality (overall) of greater than about 2.0, an OH number (overall) in the range of from about 90 to about 200 and a molecular weight (Mn) (overall) of at least about 1100. Accordingly, the foams produced in Examples 8-10 are provided for comparative purposes only and are outside the scope of the invention.

As will be further apparent, Example 11 was based on a formulation containing a mixture of vegetable oil-based polyols which, as a mixture, had an OH functionality of 2.95, an OH number of 117 and a molecular weight (Mn) of 1420. Accordingly, the foam produced in Example 11 is within the scope of the present invention.

The results of physical testing of the foams produced in Examples 8-11 are set out in Table 6.

With reference to Table 6, it can be seen that the foam produced in Example 9 had relatively good tear and tensile properties; however, the 50% compression set was relatively high and the foam is very hard (re. ILD=622 N). The foam produced in Example 10 had relatively good tear and tensile properties; however, the 50% compression set deteriorated even further (i.e., compared to the foam produced in Example 9). The degradation of properties in the foams produced in Examples 9 and 10 was such that these foams would not be useful in most applications for molded foams—e.g., vehicular applications.

With further reference to Table 6, surprisingly and unexpectedly, it can be seen that the foam produced in Example 11 had a very desirable combination of tear strength, tensile strength, 50% compression set and 50% humid aged compression set. The foam produced in Example 11 has a combination of properties that is clearly superior to that of the foams produced in Examples 9 and 10. Further, the foam produced in Example 11 has a combination of properties that, on balance, is quite desirable when compared with a conventional foam made using a polymer polyol as a load building component (Example 8).

### EXAMPLES 12-13

In these Examples, various foam samples were produced using the formulations set out in Table 7 and the general methodology described above.

As will be apparent, each of Examples 12 and 13 was based on a formulation containing a mixture of vegetable oil-based polyols which, as a mixture, had an OH functionality of 3.4, an OH number of 145.5 and a molecular weight (Mn) of 1310. Accordingly, the foams produced in Examples 12 and 13 are within the scope of the present invention.

The results of physical testing of the foams produced in Examples 12-13 are set out in Table 8.

With reference to Table 8, it can be seen that the addition of a biocide additive (Example 13) did not have a significant effect on the physical mechanical properties of the foam.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1

| | Example | | |
|---|---|---|---|
| Ingredient | 1 | 2 | 3 |
| E-833 | 60.00 | 60.00 | 60.00 |
| SOBP #1 | — | 40.00 | 20.00 |
| SOBP #2 | 40.00 | — | 20.00 |
| Water | 3.00 | 3.00 | 3.00 |
| DEOA-LF | 0.40 | 0.40 | 0.40 |
| 33-LV | 0.55 | 0.55 | 0.55 |
| PC-77 | 0.13 | 0.13 | 0.13 |
| BL19 | 0.08 | 0.08 | 0.08 |
| Y-10858 | 0.10 | 0.10 | 0.10 |
| B-4690 | 0.40 | 0.40 | 0.40 |
| B-8240 | 0.60 | 0.60 | 0.60 |

| | |
|---|---|
| ISO #1 | sufficient amount for isocyanate index = 100 |

TABLE 2

| | Example | | |
|---|---|---|---|
| Physical Property | 1 | 2 | 3 |
| Density (kg/m³) | 49 | 49 | 49 |
| Resiliency (%) | 20 | 50 | 28 |
| 50% ILD (N) | 1551 | 266 | 549 |
| 50% Compression Set (%) | 58 | 9 | 14 |
| 50% HACS (%) | 59 | 12 | 14 |
| Tear Strength (N/m) | 294 | 81 | 140 |
| Tensile Strength (N) | 246 | 78 | 109 |
| Elongation (%) | 55 | 86 | 58 |

TABLE 3

Example

| Ingredient | 4 | 5 | 6 | 7 |
|---|---|---|---|---|
| E-833 | 82.00 | 85.00 | 60.00 | 76.00 |
| SOBP #1 | — | — | 40.00 | 16.00 |
| SOBP #2 | — | 15.00 | — | 8.00 |
| E-850 | 18.00 | — | — | — |
| DEOA-LF | 0.80 | — | — | — |
| Water | 3.60 | 3.60 | 3.60 | 3.60 |
| 33-LV | 0.45 | 0.45 | 0.45 | 0.45 |
| PC-77 | — | 0.22 | 0.22 | 0.22 |
| ZF-10 | 0.15 | 0.15 | 0.15 | 0.15 |
| V-4053 | — | 2.00 | 2.00 | 2.00 |
| Y-10858 | — | 0.10 | 0.10 | 0.10 |
| B-4690 | 0.50 | 0.40 | 0.40 | 0.40 |
| B-5164 | 0.15 | — | — | — |
| B-8240 | — | 0.60 | 0.60 | 0.60 |

| | |
|---|---|
| ISO#1 | sufficient amount for isocyanate index = 100 |

TABLE 4

Example

| Physical Property | 4 | 5 | 6 | 7 |
|---|---|---|---|---|
| Density (kg/m³) | 45 | 45 | 45 | 45 |
| Resiliency (%) | 51 | 37 | 37 | 38 |
| 50% ILD (N) | 468 | 729 | 549 | 682 |
| 50% Compression Set (%) | 25 | 36 | 57 | 28 |
| 50% HACS (%) | 18 | 45 | 56 | 35 |
| Tensile Strength (N) | 141 | 154 | 113 | 134 |
| Elongation (%) | 81 | 41 | 33 | 40 |

TABLE 5

Example

| Ingredient | 8 | 9 | 10 | 11 |
|---|---|---|---|---|
| E-833 | 90.00 | 85.00 | 60.00 | 76.00 |
| SOBP #1 | — | — | 40.00 | 16.00 |
| SOBP #2 | — | 15.00 | — | 8.00 |
| E-850 | 10.00 | — | — | — |
| DEOA-LF | | | | |
| Water | 3.40 | 3.40 | 3.40 | 3.40 |
| 33-LV | 0.50 | 0.45 | 0.45 | 0.45 |
| PC-77 | — | 0.22 | 0.22 | 0.22 |
| ZF-10 | 0.15 | 0.15 | 0.15 | 0.15 |
| V-4053 | — | 2.25 | 2.25 | 2.25 |
| B-4690 | 0.40 | 0.40 | 0.40 | 0.40 |
| B-5164 | 0.15 | — | — | — |
| B-8240 | — | 0.10 | 0.10 | 0.10 |

| | |
|---|---|
| ISO#2 | sufficient amount for isocyanate index = 100 |

TABLE 6

Example

| Physical Property | 8 | 9 | 10 | 11 |
|---|---|---|---|---|
| Density (kg/m³) | 45 | 45 | 45 | 45 |
| Resiliency (%) | 59 | 40 | 42 | 44 |
| 50% ILD (N) | 428 | 622 | 476 | 509 |
| 50% Compression Set (%) | 20 | 19 | 27 | 13 |
| Tear Strength (N/m) | 266 | 142 | 103 | 106 |
| Tensile Strength (N) | 138 | 149 | 130 | 133 |
| Elongation (%) | 89 | 53 | 54 | 57 |

TABLE 7

Example

| Ingredient | 12 | 13 |
|---|---|---|
| E-833 | 60.00 | — |
| V-4701 | — | 60.00 |
| SOBP #1 | 20.00 | 20.00 |
| SOBP #2 | 20.00 | 20.00 |
| Water | 3.00 | 3.00 |
| 33-LV | 0.55 | 0.75 |
| PC-77 | 0.13 | 0.15 |
| BL19 | 0.08 | — |
| ZF-10 | — | 0.15 |
| V-4053 | — | — |
| Y-10858 | 0.10 | 0.10 |
| B-4690 | 0.40 | 0.20 |
| Biocide | — | 1.00 |
| B-8240 | 0.60 | 0.40 |

| | |
|---|---|
| ISO#1 | sufficient amount for |
| | isocyanate index = 100 |

TABLE 8

Example

| Physical Property | 12 | 13 |
|---|---|---|
| Density (kg/m³) | 49 | 48 |
| Resiliency (%) | 28 | 29 |
| 50% ILD (N) | 549 | 560 |
| 50% Compression Set (%) | 14 | 14 |
| 50% HACS (%) | 14 | 14 |
| Tear Strength (N/m) | 140 | 136 |
| Tensile Strength (N) | 109 | 110 |
| Elongation (%) | 58 | 58 |

1. An isocyanate-based polymer foam derived from a reaction mixture comprising:
(a) an isocyanate;
(b) a mixture of active hydrogen-containing compounds; and
(c) a blowing agent;
wherein the mixture of active hydrogen-containing compounds comprises: (i) a bio-based polyol having an OH functionality of greater than about 2.0, an OH number in the range of from about 90 to about 200 and a molecular weight (Mn) of at least about 1100, and (ii) a petroleum-based active hydrogen-containing compound.

2. The isocyanate-based polymer foam defined in claim 1, wherein the bio-based polyol comprises a vegetable oil-based polyol.

3. The isocyanate-based polymer foam defined in claim 2, wherein the vegetable oil-based polyol has an OH functionality in the range of from about 2.5 to about 5.0.

4. The isocyanate-based polymer foam defined in claim 2, wherein the vegetable oil-based polyol has an OH functionality in the range of from about 2.5 to about 4.5.

5. (canceled)

6. (canceled)

7. The isocyanate-based polymer foam defined in claim 2, wherein the vegetable oil-based polyol has an OH number in the range of from about 100 to about 200.

8. The isocyanate-based polymer foam defined in claim 2, wherein the vegetable oil-based polyol has an OH number in the range of from about 120 to about 180.

9. (canceled)

10. (canceled)

11. The isocyanate-based polymer foam defined in claim 2, wherein the vegetable oil-based polyol has a molecular weight (Mn) in the range of from about 1100 to about 1600.

12. The isocyanate-based polymer foam defined in claim 2, wherein the vegetable oil-based polyol has a molecular weight (Mn) in the range of from about 1200 to about 1600.

13. (canceled)

14. (canceled)

15. The isocyanate-based polymer foam defined in claim 2, wherein the vegetable oil-based polyol comprises a mixture of vegetable oil-based polyols.

16. The isocyanate-based polymer foam defined in claim 2, wherein the vegetable oil-based polyol comprises: (i) a first modified vegetable oil-based polyol having an OH functionality greater than about 2, an OH number greater than about 100 and a molecular weight (Mn) of less than about 1500; and (ii) a second modified vegetable oil-based polyol different than the first modified vegetable oil-based polyol, the second modified vegetable oil-based polyol having an OH functionality less than about 2, an OH number less than about 100 and a molecular weight (Mn) of greater than about 1000.

17. The isocyanate-based polymer foam defined in claim 16, wherein the first modified vegetable oil-based polyol has an OH functionality in the range of from about 2 to about 6.

18. The isocyanate-based polymer foam defined in claim 16, wherein the first modified vegetable oil-based polyol has an OH functionality in the range of from about 2.5 to about 5.5.

19. (canceled)

20. (canceled)

21. The isocyanate-based polymer foam defined in claim 16, wherein the first modified vegetable oil-based polyol has an OH number greater than about 125.

22. The isocyanate-based polymer foam defined in claim 16, wherein the first modified vegetable oil-based polyol has an OH number greater in the range of from about 125 to about 300.

23. (canceled)

24. (canceled)

25. (canceled)

26. The isocyanate-based polymer foam defined in claim 16, wherein the first modified vegetable oil-based polyol has a molecular weight in the range of from about about 500 to about 1500.

27. (canceled)

28. The isocyanate-based polymer foam defined in claim 16, wherein the second modified vegetable oil-based polyol comprises epoxide moieties.

29. The isocyanate-based polymer foam defined in claim 16, wherein the second modified vegetable oil-based polyol has an epoxy oxygen content of from about 0.1 to about 15 weight percent.

30. (canceled)

31. (canceled)

32. (canceled)

33. The isocyanate-based polymer foam defined in claim 16 The isocyanate-based polymer foam defined in any one of claims 16-31, wherein the second modified vegetable oil-based polyol has an average epoxy functionality greater than about 1.0.

34. The isocyanate-based polymer foam defined in claim 16, wherein the second modified vegetable oil-based polyol has an average epoxy functionality in the range of from about 2.0 to about 6.0.

35. (canceled)

36. (canceled)

37. (canceled)

38. The isocyanate-based polymer foam defined in claim 16, wherein the second modified vegetable oil-based polyol has an OH functionality in the range of from about 0.5 to about 2.0.

39. The isocyanate-based polymer foam defined in claim 16, wherein the second modified vegetable oil-based polyol has an OH functionality in the range of from about 0.8 to about 2.0.

40. (canceled)

41. (canceled)

42. (canceled)

43. The isocyanate-based polymer foam defined in claim 16, wherein the second modified vegetable oil-based polyol has an OH number in the range of from about 25 to about 100.

44. The isocyanate-based polymer foam defined in claim 16, wherein the second modified vegetable oil-based polyol has an OH number in the range of from about 40 to about 80.

45. (canceled)

46. The isocyanate-based polymer foam defined in claim 16, wherein the second modified vegetable oil-based polyol has a molecular weight of greater than about 1200.

47. The isocyanate-based polymer foam defined in claim 16, wherein the second modified vegetable oil-based polyol has a molecular weight in the range of from about 1200 to about 2000.

48. (canceled)

49. (canceled)

50. (canceled)

51. (canceled)

52. The isocyanate-based polymer foam defined in claim 1, wherein the petroleum-based active hydrogen-containing compound is selected from the group comprising polyols, polyamines, polyamides, polyimines and polyolamines.

53. The isocyanate-based polymer foam defined in claim 1, wherein the petroleum-based active hydrogen-containing compound comprises a polyol.

54. (canceled)

55. (canceled)

56. (canceled)

57. (canceled)

58. The isocyanate-based polymer foam defined in claim 53, wherein the polyol has a molecular weight in the range of from about 200 to about 10,000.

59. (canceled)

60. (canceled)

61. (canceled)

62. (canceled)

63. (canceled)

64. (canceled)

65. (canceled)

66. The isocyanate-based polymer foam defined in claim 1, wherein the isocyanate is selected from the group comprising hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4-diisocyanate, naphthalene-1,5-diisocyanate, triphenylmethane-4,4′,4″-triisocyanate, isopropylbenzene-alpha-4-diisocyanate and mixtures thereof.

67. (canceled)

68. (canceled)

69. (canceled)

70. The isocyanate-based polymer foam defined in claim 1, wherein the isocyanate is selected from the group consisting essentially of (i) 2,4′-diphenylmethane diisocyanate, 4,4′-diphenylmethane diisocyanate, variants thereof and mixtures thereof; (ii) 2,4-toluene diisocyanate, 2,6-toluene diisocyanate, variants thereof and mixtures thereof; and (iii) mixtures of (i) and (ii).

71. (canceled)

72. (canceled)

73. (canceled)

74. A molded foam article comprising the isocyanate-based polymer foam defined in claim 1.

75. A slab foam article comprising the isocyanate-based polymer foam defined in claim 1.

76. A seat device comprising the isocyanate-based polymer foam defined in claim 1.

77. (canceled)

78. (canceled)

79. (canceled)

80. A polyol composition comprising: (i) a first modified vegetable oil-based polyol having an OH functionality greater than about 2, an OH number greater than about 100 and a molecular weight (Mn) of less than about 1500; and (ii) a second modified vegetable oil-based polyol different than the first modified vegetable oil-based polyol, the second modified vegetable oil-based polyol having an OH functionality less than about 2, an OH number less than about 100 and a molecular weight (Mn) of greater than about 1000.

81-115. (canceled)
